(19) United States
(12) Patent Application Publication
(10) Pub. No.: US 2026/0125947 A1
(43) Pub. Date: May 7, 2026

(54) FITTING ARRANGEMENT FOR A FRAME TO AN OPENABLE ELEMENT AND METHOD OF ARRANGING A FITTING ARRANGEMENT TO A FRAME OF AN OPENABLE ELEMENT

(71) Applicant: INDUSTRILÅS I NÄSSJÖ AKTIEBOLAG, Nässjö (SE)

(72) Inventor: Rickard HANSSON, NASSJO (SE)

(73) Assignee: INDUSTRILÅS I NÄSSJÖ AKTIEBOLAG, Nässjö (SE)

(21) Appl. No.: 19/117,439

(22) PCT Filed: Oct. 3, 2023
(86) PCT No.: PCT/EP2023/077327

§ 371 Date: Apr. 1, 2025

(30) Foreign Application Priority Data
Oct. 3, 2022 (EP) 22199353.8

(51) Int. Cl. E06B 5/11; E05B 9/08; E06B 1/52; E06B 1/60

(52) U.S. Cl. CPC E06B 5/11; E05B 9/08; E06B 1/52; E06B 1/6023

(57) ABSTRACT

A fitting arrangement (5, 23) for a frame (3) of an openable element having a first fitting part (10) configured to be arranged onto the frame, and a fixation device (9). The fixation device includes a sleeve (26) having exterior threads and interior threads, the sleeve being configured to be attached to an opening in the frame (3) by the exterior threads, and a wall screw (12) configured to extend through the sleeve into a wall next to the frame, attaching the sleeve to the wall, and the wall screw is rotatable relative to the sleeve. A fitting screw (25) is configured to fix the first fitting part (10) to the sleeve by engaging with the inner threads of the sleeve.

### TECHNICAL FIELD

The present disclosure relates to a fitting arrangement, and especially to an arrangement which may be used in relation to the prevention of unauthorized opening of an openable element.

### BACKGROUND

An important security problem of residents and firms is the risk of burglary into their apartments, houses and offices. There is an ongoing development of locks, latch systems and hinges in order to decrease this problem and to obstruct efforts to pry open doors. A common way to pry open a door, which is locked to a frame with a latch, is to force the door away from a doorpost which the latch is connected to, and towards the doorpost where the door is connected via hinges. In such a manner, the door may be moved sufficiently for a tool to be inserted between the door and the frame and then to apply a force onto the door in the opening direction of the door. This may be done with a tool, such as a crowbar. The latch is followingly exposed to a stress from which it eventually may break. One way to counteract this problem is to produce latches with higher strength and/or more sophisticated locking connections between the door and the door frame. Another way is to have a plurality of locking latches on the door. This may however increase cost and complexity for the door installation.

Further, for any fitting arranged in connection with a door there may be a need for an improved strength to prevent obstruction at unauthorized opening of the door.

Consequently, there is a need for an improved secure arrangement for fittings for doors or other openable elements.

### SUMMARY

It is an object of the present inventive concept to provide an improved solution which alleviates the mentioned drawbacks with present solutions. Furthermore, it is an object to provide a fitting arrangement for a frame of an openable element.

The invention is defined by the appended independent claims, with embodiments being set forth in the appended dependent claims, in the following description and in the drawings.

According to the inventive concept there is provided a fitting arrangement for a frame of an openable element comprising a first fitting part configured to be arranged onto the frame, and a fixation device. The fixation device comprises a sleeve having exterior threads and interior threads, the sleeve being configured to be attached to an opening in the frame by means of the exterior threads; a wall screw configured to extend through the sleeve into a wall next to the frame, attaching the sleeve to the wall, wherein the wall screw is rotatable relative to the sleeve; and a fitting screw configured to fix the first fitting part to the sleeve by engaging with the inner threads of the sleeve.

The openable element may be a door and the frame may be a door frame, which may comprise two doorposts and a lintel. The openable element may be mounted to the frame via hinges. The first fitting part may be mounted onto one of the doorposts. Alternatively, the openable element may be a hatch, a window or the like.

The fixation device may in one embodiment comprise two or more sets of sleeve, wall screw and fitting screw. The sets may be used for attachment of the first fitting part together. Alternatively, one or more sets may be used for fixing another part to the frame.

The first fitting part may form, or form part of, a lock plate, end plate, latch arrangement, hinge or other kind of fitting for an openable element. The first fitting part may via the sleeve and the wall screw be connected to the wall, and any force exerted on the first fitting may be transported to the wall.

The sleeve may have a hollow interior, in which the interior threads may be provided. The sleeve may have one end configured to receive the fitting screw to engage with the interior threads. The sleeve may have a bottom end configured with an opening through which the wall screw may extend, at the same time as it may be configured to provide a fixation between the sleeve and the wall screw when the wall screw is attached to a wall. Especially, the bottom end may be provided with an opening allowing a threaded portion of the wall screw to extend through, while a head portion of the wall screw may not be able to extend through the opening. When the wall screw is screwed into the wall, the sleeve, attached by means of the exterior threads to the frame, may be fixed to the wall. Through the same connection the frame may be fixed to the wall.

In one embodiment, the fitting arrangement may further comprise a second fitting part configured to be arranged to the openable element, the second fitting part being configured to engage with the first fitting part. The first and second fitting parts may together form or be part of a lock arrangement, a latch arrangement, a safety arrangement or the like. In such embodiments, the first and second fitting parts may in a first state be movable relative to each other, enabling opening of the door or other openable element, and in a second state engage with each other to prevent opening. In one embodiment, the first fitting part may be a lock plate on the frame, and the second fitting part may be a lock bolt configured to lock the openable element to the frame by, in a second state (lock state) engage with the lock plate.

In one embodiment. the first fitting part may be configured to receive the second fitting part when moving the openable element into a closed state and the second fitting part may be removable from the first fitting part by movement of the openable element in an opening direction into an open state. Further, the first fitting part may be formed to receive the second fitting part in a first position or in a second position, wherein the second fitting part may be removable or separable from the first fitting part when the second fitting part is in the first position, and may be prevented from being removed or separated from the first fitting part when the second fitting part is in the second position. The second fitting part may be moved to the second position when a force is applied to the openable element, and/or the second fitting part, in a direction substantially perpendicular to the opening direction.

The following described advantages of the fitting arrangement may apply when the first fitting part is arranged onto the frame and the second fitting part onto an openable element relative the frame. However, the invention and the described advantages may be equally applicable with the first fitting part arranged onto the openable element and the second fitting part arranged onto the frame.

The fitting arrangement may prevent the openable element from being opened if efforts are performed to pry open the openable element, which may cause the openable element to move slightly in a direction substantially perpendicular to the opening direction. It may further provide a cost effective and convenient burglary protection. The present invention may decrease the need of extra or more complicated latch arrangements of the openable element. Moreover, the fitting arrangement may be less expensive to manufacture and assembly than a lock with a locking cylinder.

Efforts to pry open the openable element may include applying a force to it substantially perpendicular to the opening direction in order to move the openable element so as a space between the openable element and a post of the frame emerges or is enlarged. This may be done with a tool such as a crowbar. The configuration of the fitting parts and the fixation device may provide that the engagement between the first and second fitting parts, and thereby the openable element and the frame, may increase the more force that is applied in the direction perpendicular to the opening direction. The openable element may thereby become more difficult to open the more force that may be applied. With one or more such arrangement arranged to the openable element and the frame, a forced entry of the openable element may be made much more difficult.

Especially, the fixation device, extending into the wall next to the frame, to which the first fitting part is attached may provide a very strong attachment. An extremely high force would then be needed in order to break the engagement between the first and second fitting parts. Without the fixation device being attached to the wall, the frame might break and enable unauthorized entry through the openable element. To separate the first fitting part from the frame, it may not be sufficient to overcome the resisting force between the first fitting part and the frame. It may instead be required to also overcome resisting force between the first fitting part and the wall. Thereby increased force may be needed in the second position to pry open the openable element by separating the first fitting part from the frame. Hence, the fitting arrangement may not break as easily when the force being applied onto the fitting arrangement is transferred not only to the frame, but further to a wall.

The spacing between the frame and the openable element may enable the tool to be oriented such as a force may be applied in the opening direction in order to break a latch arranged on the openable element such as the openable element is made freely openable. The forces may be applied using one or several tools. The fitting arrangement may prevent the openable element from being opened if a space between the openable element and a post of the frame is increased or emerged. The space may be needed to insert a crowbar between the openable element and the frame such as sufficiently force may be applied in the opening direction in order to break the latch. Thereby the fitting arrangement may prevent the latch of the openable element from being broken up.

The configuration of the fitting arrangement with the first fitting part and second fitting part, wherein the second fitting part is removable from the first fitting part when in the first position, may provide that without any force applied in the direction perpendicular to the opening direction, the second fitting part is received by the first fitting part in the first position, whereupon the arrangement may not affect the regular usage of the openable element. The second fitting part, when arranged onto the openable element, may move in and out of engagement with the first fitting part with the movement of the openable element, without any significant contact with the first fitting part. Only when the second fitting part, and the openable element when in use, is moved in the direction perpendicular to the opening direction, the second fitting part is received by the first fitting part in the second position, in which it engages with the first fitting part such that removal of the second fitting part from the first fitting part in the opening direction is prevented. The direction substantially perpendicular to the opening direction may be parallel to an extension plane of the openable element and/or extending in the extension plane of the openable element.

In one embodiment the opening direction is perpendicular to the extension plane of the openable element when the fitting arrangement is arranged thereon. The extension plane of the openable element may be a vertical plane and the opening direction may be a horizontal direction. In case of the openable element being a door the door may be rotatable about one of the doorposts.

The second fitting part on the openable element may be movable in relation to the first fitting part when closing and opening the openable element. The first fitting part may be separated from the second fitting part when the openable element is in the open state. The second fitting part may engage with the first fitting part when the door is in its closed state.

In one embodiment the movement of the second fitting part from the first to the second position may be reversible. If a force is applied such as the second fitting part is moved from the first position to the second position, e.g. by someone trying to pry open the door, the second fitting part may still be movable back to the first position. Thereby the door may be openable e.g. by locking up a latch arrangement of the door, even after someone has moved the door to the second position in order to pry open it.

In one embodiment a door handle may be pulled in order to open the openable element.

In one embodiment, the first fitting part may comprise a slot and the second fitting part may be configured to move along the slot when the openable element is moved between the closed state and the open state. By the slot the first fitting part may engage with the second fitting part by moving the openable element between the closed state and the open state. The slot may be shaped and oriented such as the first fitting part may block neither the openable element nor the second fitting part when regularly closing the openable element and to receive the second fitting part without the regular closing and opening of the door being affected. When in the first and/or second position, the second fitting part may extend through the slot.

In one embodiment the second fitting part may be configured to, when received by the first fitting part, move from the first to the second position in a direction substantially perpendicular to the extension of the slot. The movement between the first and the second position being in a direction substantially perpendicular to the extension of the slot may prevent the openable element from being accidently moved from the first position into the second position, since when opening and closing the openable element, a force may typically be applied mainly in a direction along the slot, which may be in a direction in and opposite to the opening direction, respectively. Furthermore, movement in such direction may be the most beneficial to move the openable element in order to be able to stick in a crowbar between the openable element and the frame.

In one embodiment, the second fitting part may comprise a neck portion which has a width smaller than or equal to the width of the slot. The neck portion may allow the second fitting part to move along and engaging with the slot with one portion of the second fitting part being on the side of the slot closest to the openable element and another portion being on the side closest to the frame, when the second fitting part is received in the first position.

In one embodiment the second fitting part may comprise a head portion with a width that is larger than the width of the neck portion and larger than the width of the slot. In one embodiment, the head portion may have a shape which provides an increasing cross section in a direction away from the neck portion. The head portion may assure that the second fitting part is separable from the first fitting part only by movement of the second fitting part in the opening direction when the second fitting part is in the first position. The head portion may, by contact with the first fitting part, block the openable element from being opened when the second fitting part is received in the second position. The head portion may further provide that the second fitting part cannot move out of engagement with the first fitting part through the slot, in a direction perpendicular to the extension direction of the slot.

In one embodiment the first fitting part may comprise at least one first abutment surface shaped to receive at least a portion of the head portion of the second fitting part when in the first position. The at least one first abutment surface may receive the second fitting part in a stable manner and ensure that the head portion is oriented such that the second fitting part may move along the slot when the second fitting part is in the first position. The first abutment surface may be a surface at which the head portion is arranged when the second fitting part is in the first position. The head portion may be in contact with the first abutment surface when in the first position. For this purpose the at least one first abutment surface may have a shape at least partly matching a surface of the head portion so as the angle of the head portion relative the slot is prevented from being changed to such extent that the contact between the head portion and the first fitting part blocks the movement of the second fitting part along the slot when the second fitting part is in the first position. In an alternative embodiment, the second fitting part may be substantially not in contact with the first fitting part when in the first position.

In one embodiment the head portion may be too wide, in a plane perpendicular to the movement direction between the first and the second position, to be moved along the slot, when the second fitting part is in in the second position. Thereby, the second fitting part may be prevented from moving from the closed state to the open state when the second fitting part is in the second position. When a force above a threshold, in a direction substantially perpendicular to the opening direction, is applied to the door, the second fitting part may move in relation to the first fitting part to the second position. In the second position the neck portion may be in a position such as it is unable to engage with and/or move along the slot. The head portion may then be oriented such that it is blocked from moving along the slot due to the width of the head portion being larger than the width of the slot in an intersection plane of the second fitting part.

In one embodiment the first fitting part may comprise at least one second abutment surface configured to block the head portion from moving along the slot when the second fitting part is in the second position. The second fitting part may, when moved to the second position, come into contact with the second abutment surface. The at least one second abutment surface may be shaped such that when applying a force to the openable element in the opening direction, said second abutment surface may prevent the second fitting part from moving along the slot. Thereby, the openable element may be prevented by said second abutment surface from being pry opened since the second fitting part may need to be moved along the slot in order for the openable element to be moved to the open state. The second abutment surface may be provided as a recess in the first fitting part into which the head portion of the second fitting part may enter when the second fitting part is moved to the second position. The recess may have a shape corresponding to the shape of the head portion, such that the head portion and the second fitting part is prevented from moving in the opening direction when in the second position. The second abutment surface may be referred to as a head portion receiving surface, or head receiving portion, of the first fitting part. The second abutment surface may be formed as a recess in the first portion, configured to receive the head portion of the second fitting part. The second abutment surface, or head receiving portion, may be formed to block the head portion in the opening direction. The blocking may be provided by one or more protrusions which, when the second fitting part is in the second position, extend to block the head portion from moving in the opening direction.

In one embodiment the fitting arrangement may be configured to increase the force needed to break a latch locking the openable element to the frame when the second fitting part is in the second position. A force in the opening direction applied onto the openable element may be resisted by forces between the first fitting part and the second fitting part of the fitting arrangement. The strength of the first and the second fitting part may influence the force needed to be applied on the door in the opening direction to pry open the door.

In one embodiment, there may be an end plate arranged to the frame, with which end plate a locking means on the openable element may interact to lock the openable element to the frame. To provide further rigidness and strength to the locking of the openable element to the frame, the end plate may be attached to the frame and/or the wall by means of one, two or more fixation devices, which may extend through the frame into the wall.

In one embodiment the first fitting part may comprise an orientation portion configured to enhance appropriate orientation of the first fitting part relative the second fitting part when arranging the first fitting part onto the frame.

In one embodiment the second fitting part may comprise an orientation portion configured to enhance appropriate orientation of the first fitting part relative the second fitting part when arranging the second fitting part onto the openable element. The orientation portion of the second fitting part may be an integrated part of the head portion, provided by the shape of the head portion. The orientation portion of the second fitting part may be shaped to interact with the orientation portion of the first fitting part.

In one embodiment the first fitting part may comprise guiding surfaces configured to guide the head portion of the second fitting part into the slot by contact between the head portion and one of the guiding surfaces. If there is an offset between the position of the first fitting part and its optimal position relative the second fitting part in order for the second fitting part to be received by the first fitting part when closing the openable element, the second fitting part may move towards said optimal position by contact between the head portion and one of the guiding surfaces. Such movement may be in a direction substantially perpendicular to the opening direction of the openable element. The guiding surfaces may be inclined relative to a longitudinal extension direction of the second fitting part.

In one embodiment, the openable element may be a door, and the frame may be a door frame. Alternatively, the openable element may be a hatch or a window.

In one embodiment, the opening direction may be perpendicular to the extension plane of the openable element.

In one embodiment, the first fitting part may be arranged to two fixation devices, wherein the longitudinal center lines of the two fixation devices form a line, and wherein a longitudinal center line of the second part, when in the first position, may be offset said line by a distance of at least 2 mm, preferably by between 2-15 mm. In alternative embodiments, the distance may be between 2-10 mm or between 4-6 mm. The longitudinal center lines of the fixation devices may extend along the longitudinal extension of the sleeve and/or wall screw. The longitudinal center line of the second part may extend along the longitudinal extension of the head portion and/or neck portion and/or

[symbol]

In one embodiment the first fitting part may be a first hinge part configured to be arranged on a post of the frame at a hinge side of the openable element, and the second fitting part may be a second hinge part configured to be arranged on the openable element being openable relative to the frame. The second hinge part, when the door is in a closed position, may engage with the first hinge part such that separation of the first and second hinge parts is only enabled by movement of the door towards an open position. The first and second hinge parts may be formed as or on respective parts of a hinge arranged to the frame and the openable element.

In one embodiment, the fitting screw may comprise an adaptor configured to be in threaded connection with the interior threads of the sleeve, wherein the adaptor comprises a hollow interior with threads configured to receive the screw in threaded engagement. The adaptor may comprise outer threads configured to engage with the interior threads of the sleeve. In one embodiment the interior of the sleeve may initially be unthreaded, and the adaptor may be configured to be thread cutting, forming interior threads in the sleeve when mounted therein.

According to another aspect of the invention, a door arrangement is provided comprising a door or other openable element, a frame and at least one fitting arrangement according to any one of the embodiments above, arranged to the frame and/or the door.

In the context of the present application, when in the closed state the openable element may be in a locked or an unlocked state in relation to the frame.

According to a further aspect of the inventive concept, there is provided a method of arranging a fitting arrangement to a frame of an openable element. The method comprises the steps of arranging a sleeve of a fixation device in an opening in the frame by means of exterior threads on said sleeve; arranging a wall screw through the sleeve and the frame into a wall next to the frame, such that the sleeve is attached to the wall; arranging a first fitting part on the frame and attaching the first fitting part to the sleeve by means of a fitting screw engaging with interior threads in a hollow interior on the sleeve. The sleeve may be arranged to the frame prior to arranging the wall screw through the sleeve and into the wall. After attachment of the wall screw to the wall, fixing the sleeve to the wall, the fitting screw may be engaged with the interior threads of the sleeve to attach the first fitting part to the sleeve. The first fitting part may thereby be connected to the wall, and any force exerted on the first fitting may be transported to the wall. The fitting arrangement may be a fitting arrangement according to any of the embodiments described above. The method may in some embodiments comprise further steps of arranging a fitting arrangement according to such embodiments to the frame of the openable element.

### BRIEF DESCRIPTION OF THE DRAWINGS

The invention will in the following be described in more detail with reference to the enclosed drawings, wherein:

FIG. 1 shows a vertical view of a frame and an openable element according to an embodiment of the invention.

FIG. 2 shows a horizontal view of a frame and an openable element according to an embodiment of the invention.

FIG. 3 shows a horizontal view of a frame and an openable element according to an embodiment of the invention.

FIG. 4 shows a perspective view of a fitting arrangement with parts arranged onto a frame and an openable element according to an embodiment of the invention.

FIG. 5 shows a perspective view of a frame and two fitting arrangements according to an embodiment of the invention.

FIG. 6 shows a perspective view of a fitting arrangement according to an embodiment of the invention.

FIG. 7 shows a perspective view of a fitting arrangement according to an embodiment of the invention.

FIG. 8 shows a perspective view of a fitting arrangement according to an embodiment of the invention.

FIG. 9 shows a perspective view of a first fitting part of a fitting arrangement according to an embodiment of the invention.

FIG. 10 shows a side view of a fitting arrangement according to an embodiment of the invention.

FIG. 11 shows a perspective view of a fitting arrangement according to an embodiment of the invention.

FIG. 12 shows a side view of a fitting arrangement according to an embodiment of the invention.

FIG. 13 shows a perspective view of a fitting arrangement according to an embodiment of the invention.

FIG. 14 shows a perspective view of a fitting arrangement according to an embodiment of the invention.

FIG. 15 shows a perspective view of a fitting arrangement according to an embodiment of the invention.

FIG. 16 shows a side view of a fitting arrangement according to an embodiment of the invention.

FIG. 17 shows a side view of a fitting arrangement according to an embodiment of the invention.

FIG. 18 shows a perspective view of a fitting arrangement according to an embodiment of the invention.

FIG. 19 shows a perspective view of a fitting arrangement according to an embodiment of the invention.

FIG. 20 shows a top view of a fitting arrangement according to an embodiment of the invention.

FIG. 21 shows a perspective view of a hinge with a fitting arrangement.

### DESCRIPTION OF EMBODIMENTS

The present invention will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements.

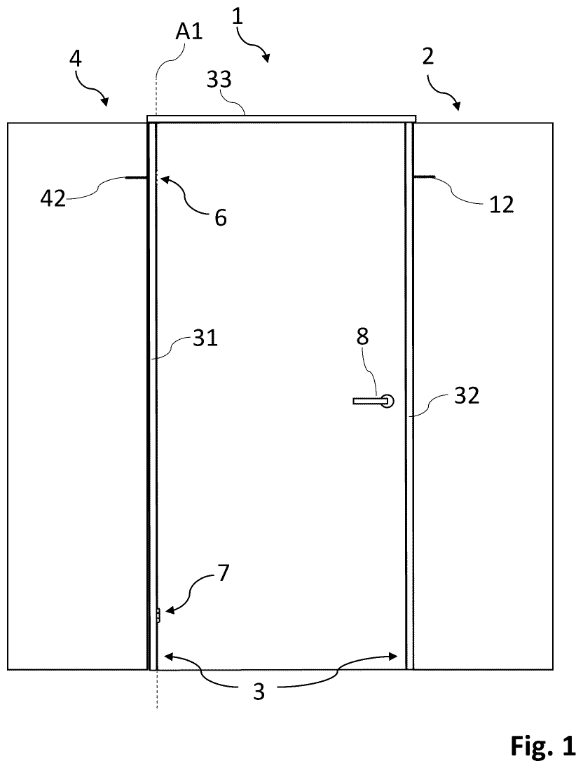

An openable element 1, here being a door, is illustrated in FIGS. 1, 2 and 3, with a frame 3. Hereinafter orientational terms will be used, applicable for embodiments in which the opening direction of said openable element 1 is in a horizontal opening direction D1 and the extension of the openable element 1 in a vertical plane, which is normal for a door, but the present invention may be applicable also for an openable element 1 being oriented differently. For instance, the present invention may be applicable for an openable element 1 being a ceiling or floor shutter, for which the opening direction may be vertical. The openable element 1 may as well be for a locker, a cabinet or a safe.

In FIG. 1 the openable element 1 is illustrated from a vertical perspective such as the openable element 1 may be in a closed as well as an open state relative the frame 3. The frame 3 may comprise two posts 31, 32 and one lintel 33. The lintel 33 may be connected to the posts 31, 32, at two opposite sides of the lintel 33. In the illustrated embodiment the posts 31, 32 are perpendicular to the lintel 33 and mutually parallel. The openable element 1 is connected to the post 31 with hinges 6, 7 so as it is rotatable about an axis A1 extending through the hinges 6,7. A handle 8, by which the openable element 1 may be opened, is also seen.

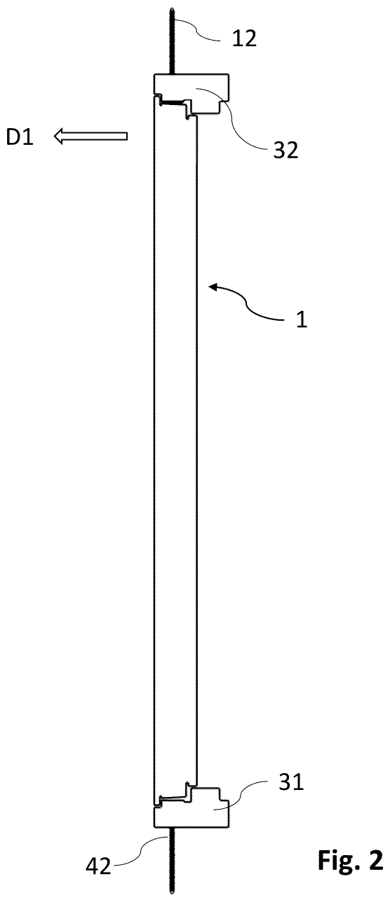

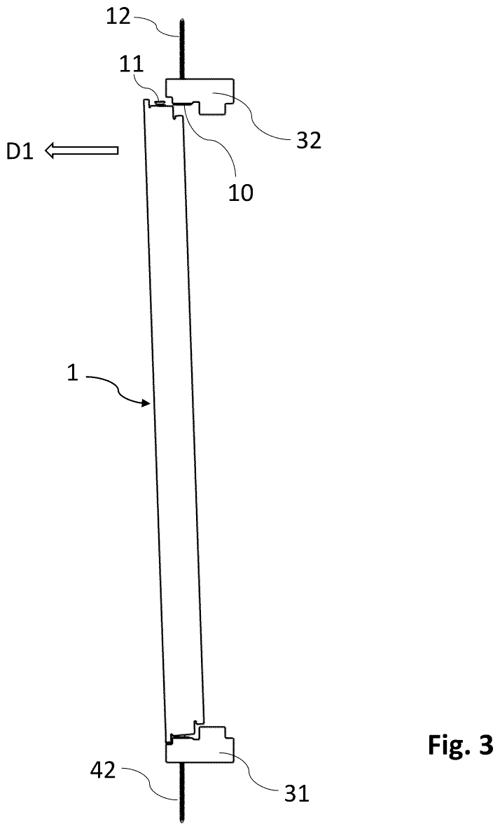

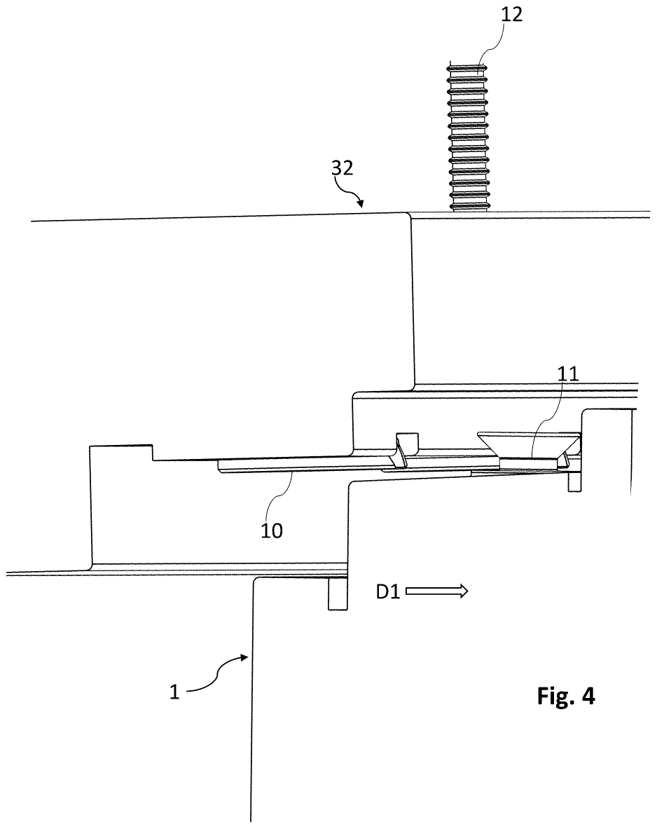

In FIGS. 2 and 3 the openable element 1 is illustrated from a horizontal perspective, in a closed and an open state, respectively, relative the frame 3, the opening direction D1 here being to the left. An illustration of a closer perspective of the openable element 1 from a vertical perspective, in the open state, relative the frame 3, is shown in FIG. 4. Here the opening direction D1 is to the right.

In some of the illustrated embodiment, a fitting arrangement according to the invention may be described as comprising a fitting arrangement 5. The fitting arrangement 5 is illustrated to be arranged on the frame 3 and the openable element 1. The fitting arrangement 5 comprises a first fitting part 10 and a second fitting part 11. In the figures the first and second fitting parts 10, 11 of the fitting arrangement 5 are seen arranged onto the post 32 and the openable element 1, respectively.

The second fitting part 11 may also be seen in FIG. 3 whereas the first fitting part 10, in the illustrated embodiment, to some extent is concealed by the post 32, which it partly extends within. A screwing means 12 connecting the first fitting part 10 of the fitting arrangement 5 to the wall 2, through the post 32, is seen in FIGS. 1, 2 and 3. The screwing means 12 is part of a fixation device (9). The fixation device 9 comprises frame attachment means which is rotatable relative said screwing means 12, enabling translatory adjustment of the position of the post 32 when said screwing means 12 are screwed into the wall 2.

The second fitting part 11 may as well be a solid portion of the openable element 1.

At least one first fitting part 10 may also be possible to arrange onto a frame 3 portion extending perpendicular to the axis A1 of the and a second fitting part 11 on a corresponding surface of the openable element 1. In case of the openable element 1 being a door, a first fitting part 10 may thereby be arranged onto the lintel 33 as well as onto a doorpost 31, 32. Such an arrangement may especially prevent pry opening with a force applied at an upper portion of the openable element 1.

Embodiments in which the openable element 1, onto which the second fitting part 11 of the fitting arrangement 5 is arranged, is not rotatable about an axis A1, may also be possible, such as for which the openable element 1 is entirely removable from the frame 3, by a translatory movement. For such embodiments fitting arrangements 5 may be applicable on at least one pair of mutually opposite portions of a frame 3, relative an openable element 1.

In one embodiment in addition to at least one second fitting part 11 of a fitting arrangement 5, a latch is arranged onto the openable element 1 and in addition to at least one first fitting part 10 of a fitting arrangement 5, a latch receiving means is arranged onto the frame 3, e.g. onto the post 32.

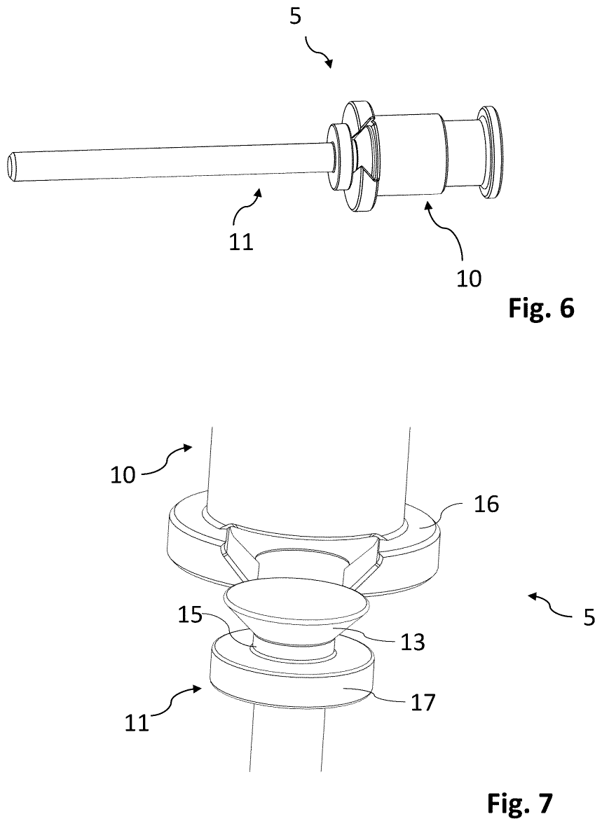

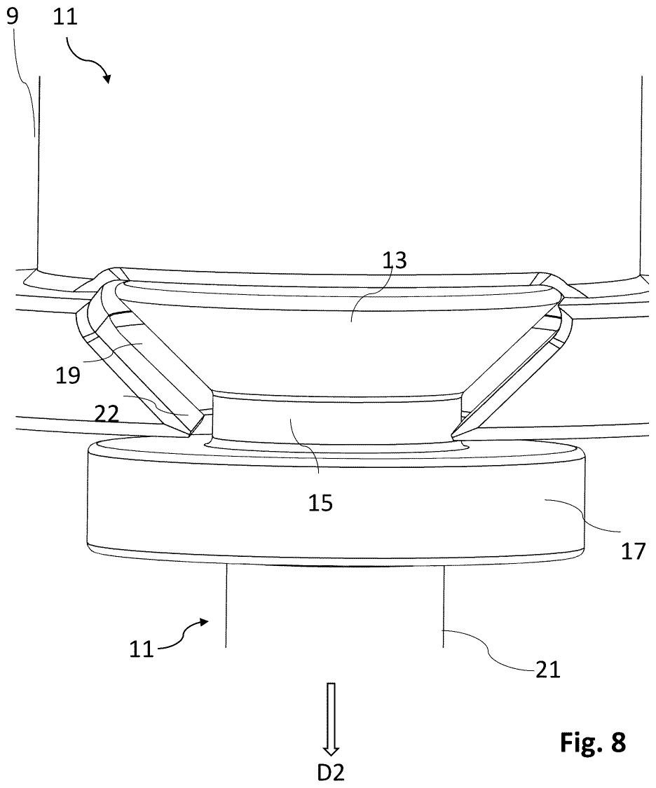

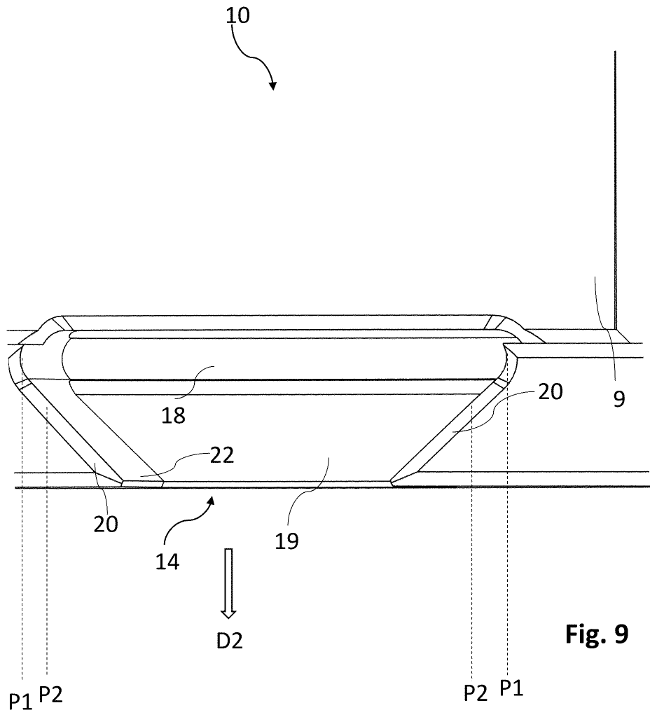

Portions of the first fitting part 10 configured to interact with portions of the second fitting part 11 are seen in FIG. 9. The first fitting part 10 comprises a first abutment surface 18, a second abutment surface 19, optionally a first orientation portion 16 and further optionally guiding surfaces 20. The first fitting part 10 is configured to receive the second fitting part 11 in a first position by the first abutment surface 18 and in a second position by the second abutment surface 19. The second fitting part 11 is received at the second abutment surface 19 in the second position after movement of the second fitting part 11 from the first position in a forcing direction D2. A fitting arrangement 5 in a state corresponding to the closed state of the openable element 1 is illustrated without the frame 3 and the openable element 1 in FIG. 6 and in a closer perspective view in FIG. 8. Further, the fitting arrangement 5 is illustrated in an open state in FIG. 7.

The second fitting part 11 of the fitting arrangement 5 comprises a head portion 13, a neck portion 15, an attachment portion 21 and optionally an orientation portion 17. In the illustrated embodiment, the second fitting part 11 is rotational symmetric but other embodiments are also possible. The second fitting part 11 is configured to move along the opening direction D1 and engaging with the first fitting part 10 when closing the openable element 1 in the opposite of the opening direction D1. In the closed state of the openable element 1, as seen in FIGS. 6 and 8, the head portion 13 is inside the slot 14 of the first fitting part 10. The slot 14 is shaped and configured to receive the head portion 13 of the second fitting part 11 and to allow the head portion 13 to be movable within the first fitting part.

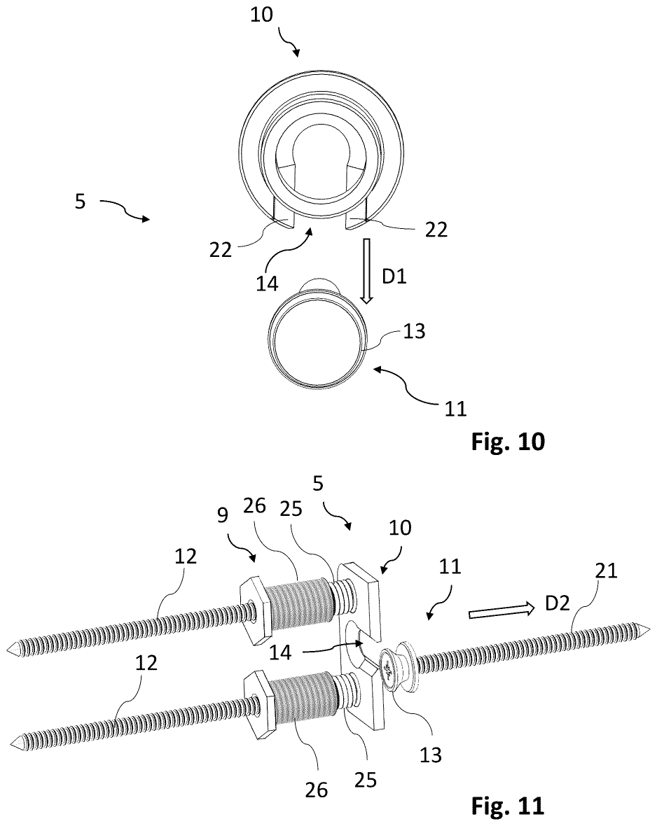

In FIG. 10 the first fitting part 10 and the second fitting part 11 of the fitting arrangement 5 are seen so as corresponding to the open state of the openable element 1. The attachment portion 9 of the first fitting part 10 here to a large extent being omitted in order to better see how the first fitting part 10 is to engage with the second fitting part 11. The first fitting part 10 may here be separated from the second fitting part 11. The second fitting part 11 may from this state move along the slot 14, opposite to the opening direction D1 of the openable element 1, in order to be received by the first fitting part 10, such as the head portion 13 moves into and inside the slot 14, into a first position, corresponding to a closed state of the door, which is illustrated in FIGS. 6 and 8.

When the second fitting part 11 is received by the first fitting part 10 in the first position the second fitting part 11 is movable in the opening direction. The second fitting part 11 is illustrated with the neck portion 15 being narrower than the edges 22 of the slot 14, so as the neck portion 15 is not blocked by the edges 22 of the slot 14 when the openable element 1 is moved from the open state into the closed state if the first fitting part 10 is oriented appropriate relative the second fitting part 11. Embodiments where it has the same width as the slot 14 may be possible, in such a case there may be a contact between the neck portion 15 and the edges 22 of the slot 14 at some point when the openable element 1 is moved between the closed and the open state.

The head portion 13 is shaped such that the second fitting part 11 is not blocked by the edges 22 of the slot 14 when entering into the first fitting part 10, if the first fitting part 10 is oriented appropriate relative the second fitting part 11. In order to be so, the second fitting part 11 should be arranged onto the openable element 1 at appropriate location in relation to where the first fitting part 10 is arranged onto the frame 3, in terms on what height, horizontal position and how much the head portion 13 is protruding out from the openable element 1. If the head portion 13 is protruding too little from the openable element 1 the head portion 13 may be blocked by surfaces of the slot 14 and if it is protruding too much it may be blocked the frame 3. The first fitting part 10 has optionally a first orientation portion 16, configured to facilitate an appropriate orientation when arranging it onto the post 32. One surface of the optional first orientation portion 16, is configured to be in contact with the frame 3. In the illustrated embodiment the first orientation portion 16 is shaped as a disc and the slot 14 is extending through the first orientation portion 16. The second fitting part 11 has optionally a second orientation portion 17, configured to facilitate an appropriate orientation when arranging it onto the openable element 1. One side of the second orientation portion 17 is configured to be in contact with the openable element 1.

In the illustrated embodiment the head portion 13 has a conical frustum shape but other shapes are possible dependent on the shape of the first fitting part 10. Other shapes of the neck portion 15, which is illustrated as cylindrical or disc shaped may also be possible dependent on the shape of the first fitting part 10.

In some embodiments the second fitting part 11 is somewhat flexible in relation to the openable element 1, the second fitting part 11 being arranged at an offset from an optimal location along the side of the openable element 1 where it is arranged on the openable element 1 in relation to the first fitting part. If the offset is sufficiently small, dependent on said flexibility, one of the guiding surfaces 20, seen in FIG. 9, may guide the second fitting part 11 into the slot 14 by contact between said guiding surface 20 and the second fitting part 11, when closing the openable element 1.

Further, the first abutment surface 18 is configured to receive the head portion 13 in the first position so as the head portion 13 is in contact with the first abutment surface 18. From the first abutment surface 18 the head portion 13, and the neck portion 15 may move along the slot 14, when the openable element 1 is moved towards the open state relative the frame 3. If, when the head portion 13 is received in the first position, a force is applied to the openable element 1, in a forcing direction D2, being substantially perpendicular to the opening direction D1, the head portion 13 may be moved to be received by a second abutment surface 19 in the second position. Such a force may be caused by efforts to pry open the openable element 1. The force in the forcing direction D2 may be applied with a tool such as a crowbar in order to be able to apply force in the opening direction, for instance by sticking in the crowbar between the opening element 1 and the frame 3 such as a portion of it is located at opposite side of the openable element 1 relative the opening direction. The second abutment surface 19 is shaped to prevent the head portion 13 from being moved along the slot 14 in the opening direction D1 when the second fitting part 11 of the openable element 1 is received in the second position. The head portion 13 is then oriented so that its cross section is too large for it to move along the slot 14, from the second position, since it is blocked by the second abutment surface 19. Applied force on the openable element 1 in the opening direction D1 is then resisted by forces between the first fitting part 10 and the second fitting part 11 of the fitting arrangement 5. If at least one latch is arranged onto the openable element 1 in combination with at least one latch receiving portion onto the frame 3, the fitting arrangement 5 may thereby prevent the latch from being broken up.

Lines P1 and P2 are shown in FIG. 9, as approximate locations of the topmost, as seen in FIG. 9, boundary surface of the slot 14 for head portion 13 at the first and second position, respectively, in order to visualize the function of the first and second position. A movement from the first position to the second position, of the head portion 13, which is downward in FIG. 9 along the forcing direction D2, may result in the head portion not being movable along the slot 14, due to the width of the head portion 13 relative to the width of the slot 14 with the boundary surface at P2.

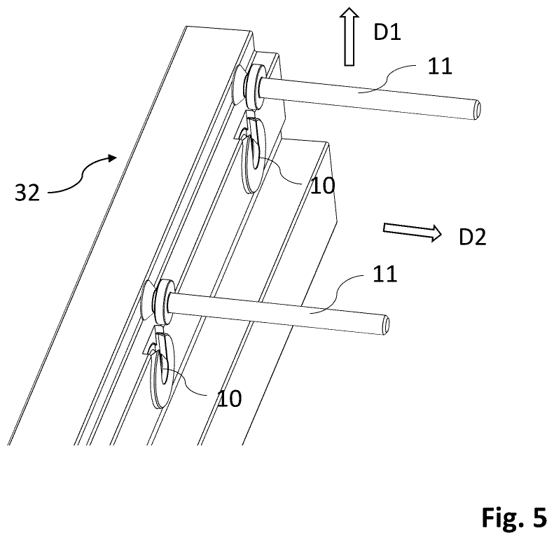

The post 32 of the frame 3 is illustrated in FIG. 5 along with two fitting arrangements 5, with first fitting parts 10 arranged onto the post 32. The openable element 1, which the second fitting parts 11 are arranged onto, is here not illustrated, in order to better see the post 32 and the fitting arrangements 5. A plurality of fitting arrangements 5 may be used in order to increase the force provided by the fitting arrangements 5 preventing the openable element 1 to be pried open. When the openable element 1 is in the second position, the applied force in the opening direction D1 is resisted by forces between first and second fitting parts 11 of a plurality of fitting arrangements 5. A plurality of fitting arrangements 5 may therefore be arranged on the post 32.

In some embodiments it may be possible to return the second fitting part 11 to the first position by relaxing the force, which moved the second fitting part 11 to the second position, and possibly applying a force in the opposite direction than the direction D2 of said force applied when moving the second fitting part 11 to the second position. In such a manner the head portion 13 may be moved to be received by the first abutment surface 18. The openable element 1 may thereafter be regularly openable by applying a force in the opening direction D1 so as the head portion 13 moves along the slot 14.

FIG. 11 illustrates an embodiment of the fitting arrangement 5 with the fixation device 9. The fixation device 9 comprises a sleeve 26, the screwing means 12, which may be a wall screw, and a fitting screw 25. The sleeve 26 has threads on an outer surface configured to engage with the frame 3 when arranged thereto. The sleeve 26 is hollow and provided with inner threads. The inner threads are configured to engage with the fitting screw 25 configured to attach the first fitting part 10 to the fixation device 9. The wall screw 12 is rotatable relative to the sleeve 26. In the illustrated embodiment there are two fixation devices 9 to which the first fitting part 10 is attached. In an alternative embodiment the first fitting part 10 may be attached to a single fixation device 9. The fixation device 9 provides a solid and strong attachment of the first fitting part 10 to the frame 3 and wall.

The first fitting part 10 in this embodiment is formed as a plate with the slot 14 extending from one side. The features of this first fitting part 10 in its engagement with the second fitting part 11 in the second position is similar to the embodiments presented above. At the end of the slot 14 the first fitting part 10 is provided with a head portion receiving surface, also named second abutment surface 19 as discussed above. When entering the slot 14, the second fitting part 11 is moved to the first position when the neck portion 15 has moved to the end of the slot 14. When the second fitting part 11 is moved in the forcing direction D2, the head portion 13 is moved to the second position to be in engagement with the slot 14, or as described above with the second abutment surface 19. In that second position, the second fitting part 11 is prevented from moving in the opening direction D1 relative to the first fitting part 10.

The head portion receiving surface is shaped to correspond to the shape of the head portion 13 of the second fitting part 11. To correspond to the cone shaped head portion 13, the head portion receiving surface is provided as a corresponding recess. Said recess is provided at or around the end of the slot 14. The head portion receiving surface, or the recess thereof, is shaped to prevent the head portion 13 to move in the opening direction D1 when the second fitting part 11 has moved to the second position.

In the embodiment illustrated in FIG. 11, the first fitting part 10 is connected to two fixation devices 9, each comprising a screwing means 12 for attachment to a wall. In another embodiment, the illustrated fitting arrangement 5 may as well be provided with only one fixation device 9. The fixation device 9 comprises a sleeve 26 onto which the first fitting part 10 is attached. In one embodiment, the first fitting part 10 may be configured for attachment to a preinstalled fixation device 9. The first fitting part 10 is attached to the fixation device 9 by means of one or more screw 25 configured to be screwed into the hollow interior of the sleeve 26. This kind of attachment of the first fitting part 10 to a wall via the fixation device 9 is applicable to any embodiment of the fittings for an openable element.

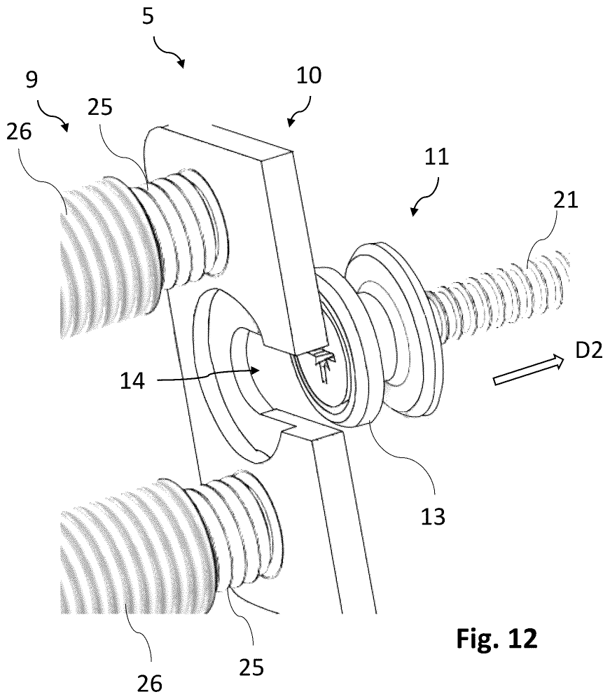

FIG. 12 illustrates an embodiment of the fitting arrangement 5 with a different design of both the first and the second fitting parts 10, 11. The second fitting part 11 has a head portion 13 and a neck portion 15. The head portion 13 is flat shaped and/or disc shaped. The first fitting part 10 is formed as a plate with the slot 14 extending from one side. The features of the first fitting part 10 in its engagement with the second fitting part 11 in the second position is similar to the embodiments presented above. At the end of the slot 14 the first fitting part 10 is provided with a head portion receiving surface, also named second abutment surface 19 as discussed above. When entering the slot 14, the second fitting part 11 is moved to the first position when the neck portion 15 has moved to the end of the slot 14. When the second fitting part 11 is moved in the forcing direction D2, the head portion 13 is moved to the second position to be in engagement with the slot 14, or as described above with the second abutment surface 19. In that second position, the second fitting part 11 is prevented from moving in the opening direction D1 relative to the first fitting part 10.

The head portion receiving surface is shaped to correspond to the shape of the head portion 13 of the second fitting part 11. To correspond to the flat or disc shaped head portion 13, the head portion receiving surface is provided as a corresponding recess. Said recess is provided at or around the end of the slot 14. The head portion receiving surface, or the recess thereof, is shaped to prevent the head portion 13 to move in the opening direction D1 when the second fitting part 11 has moved to the second position.

In the embodiment illustrated in FIG. 12, the first fitting part 10 is connected to two fixation devices 9, each comprising a screwing means (not shown in FIG. 12) for attachment to a wall. In another embodiment, the illustrated fitting arrangement 5 may as well be provided with only one fixation device 9.

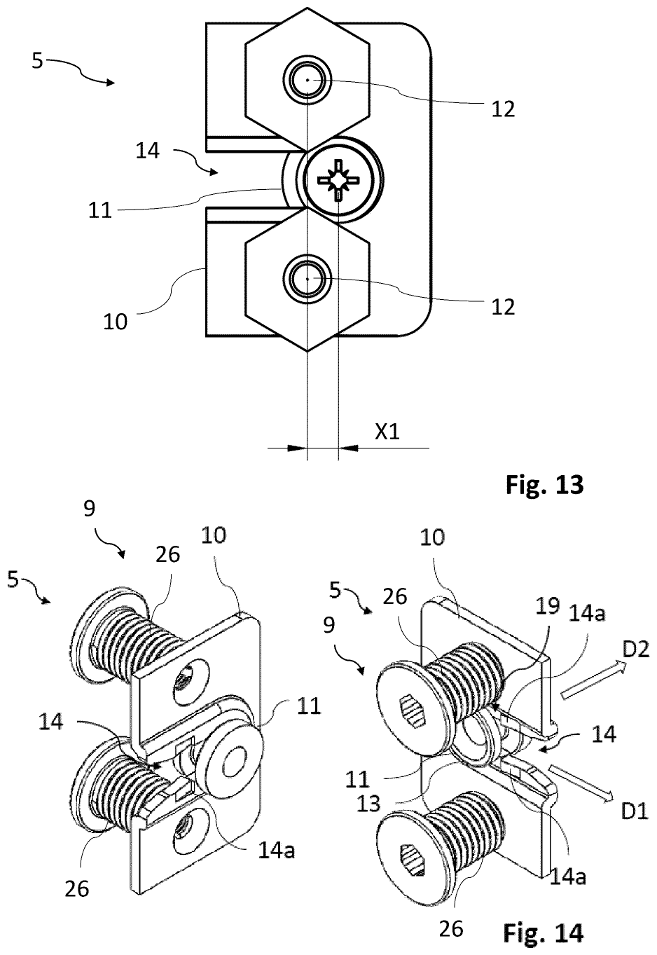

FIG. 13 illustrates an embodiment of the first fitting part 10 and the second fitting part 11 when the second fitting part 11 is in the first position. There are two screwing means 12 for the first fitting part 10, configured for attachment of the first fitting part 10 to a frame and/or a wall. The two screwing means 12 are arranged along a line. The second fitting part 11 is in the first position, and in a position where it is moveable to the second position. The center of the second fitting part 11 may then be arranged offset said line between the two screwing means of the first fitting part 10 by a distance X1. The distance X1 may be between 2-15 mm, between 2-10 mm, or between 4-6 mm. The center of the second fitting part 11 may be a radial center, a longitudinal center line, of the second fitting part 11. The second fitting part 11 may be arranged to the openable element by an attachment means 21, such as a screwing means. The attachment means 21 may have longitudinal center line which may constitute the center having an offset to the line between the screwing means 12 of the first fitting part. The line between the screwing means 12 may be formed by a line between the two longitudinal center lines of the two screwing means 12. The offset may be provided by the extension of the slot 14, providing the first position of the second fitting part 11 when the openable element is in the closed state. This function of a slot 14 configured to receive the second fitting part 11 at the first position with the described offset is applicable to any of the embodiments of the invention disclosed herein.

FIG. 14 illustrates an embodiment of the fitting arrangement 5, from two different angles, in which the second abutment surface 19, or head portion receiving surface, is formed as a part of the edges of the slot 14. Along the edges of the slot, one or two protrusions 14a is provided. The protrusions 14a extend in a direction perpendicular to the extension of the slot 14. When moving towards the open state or the closed state, the second fitting part 11 moves along the slot 14 such that the neck portion 15 extends such that the head portion 13 can move passed the protrusions 14a. This provides that the second fitting part 11 can be moved into the first position. When a force in the direction D2 is applied such that the second fitting part 11 is moved to the second position, the protrusions 14a at the edges of the slot 14 prevents the second fitting part to be moved in the opening direction D1. This is provided by the protrusions 14a blocking the way for the head portion 13. The second abutment surface 19 is formed by the protrusions 14a together with at least a part of the edge of the slot 14. The first fitting part 10 is configured to be attached to the sleeves 26 of the fixation devices 9 by means of fitting screws (not shown in FIG. 14)

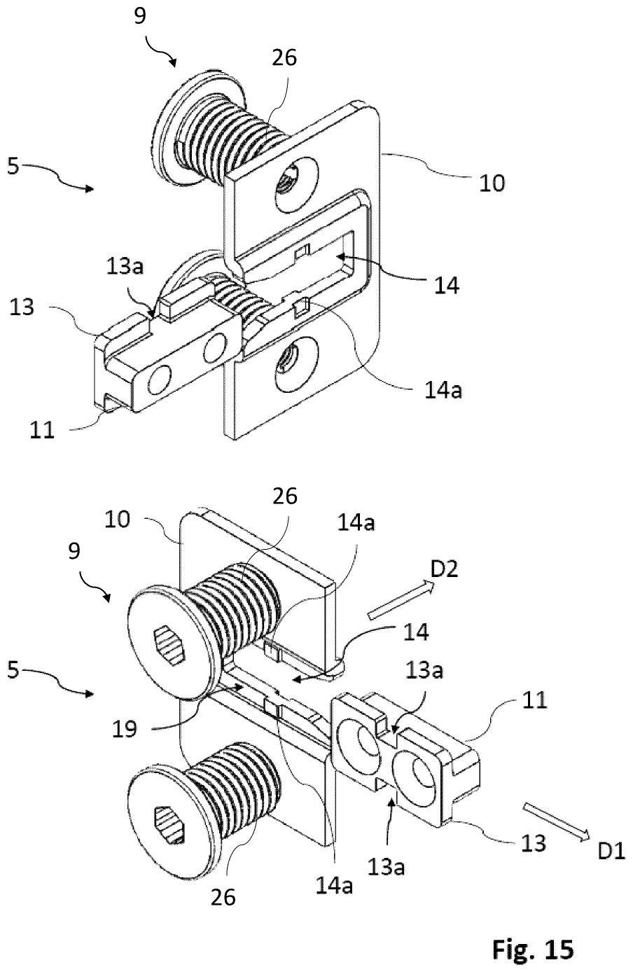

FIG. 15 illustrates an embodiment of the fitting arrangement 5, from two different angles, in which, similar to the embodiment of FIG. 14, the second abutment surface 19, or head portion receiving surface, is formed as a part of the edges of the slot 14. One or two protrusions 14a is provided along the edges of the slot 14. In the embodiment illustrated in FIG. 15, the head portion 13 of the second fitting part 11 is provided with one or two recesses 13a, corresponding in shape and size with the protrusions 14a such as to enable engagement there between. When a force in the direction D2 is applied such that the second fitting part 11 is moved to the second position, the protrusions 14a prevents the second fitting part to be moved in the opening direction D1. This is provided by the protrusions 14a blocking the way for the head portion 13. In the embodiment of FIG. 15, the blocking is further provided by the protrusions 14a coming into engagement with the recesses 13a of the head portion 13. The second abutment surface 19 is formed by the protrusions 14a together with at least a part of the edge of the slot 14. As illustrated in FIG. 15, the second fitting part 11 may have a rectangular shape. The rectangular shape may be provided both on the head portion 13 and the neck portion 15. When having a rectangular shape, the head portion 13 may be wider than the neck portion 15 in one, or preferably at least two, directions of the rectangular shape. The head portion 13 may be wider than the neck portion in the two directions facing the edges of the slot 14 when the second fitting part 11 is moved along the extension of the slot in the opening direction D1. When having a rectangular shape, the second fitting part 11 may be fixed to the openable element 1 by means of two fastening means, such as screws, when in use. This may provide a more rigid attachment to the openable element 1.

The protrusions 14a may be formed by stamping on the edges of the slot 14. The first fitting part 10 is in some embodiments formed as a plate extending in a first plane. The slot 14 may have edges extending in a second plane in parallel with, but offset from, the first plane. The second abutment surface 19 may also extend in the second plane. Such function is provided in e.g. the embodiments in FIGS. 14 and 15. In those embodiments, the protrusions extend in a direction towards the first plane.

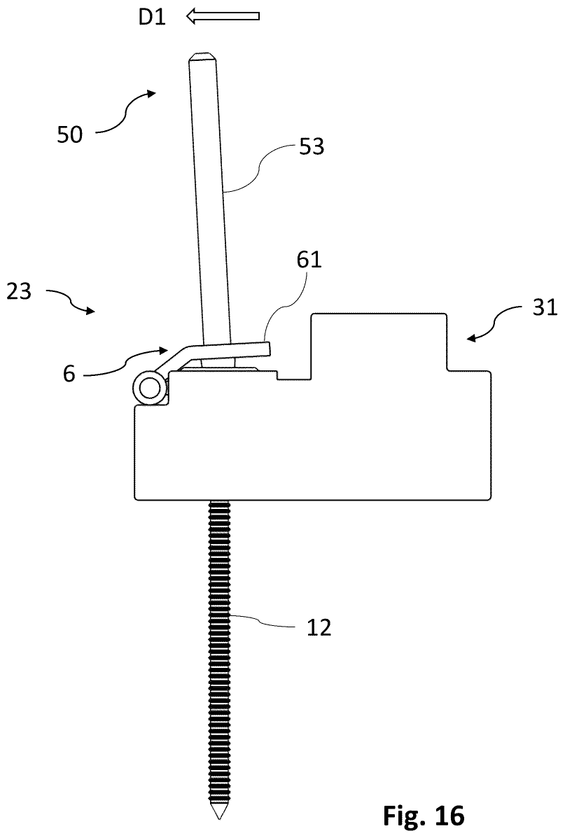

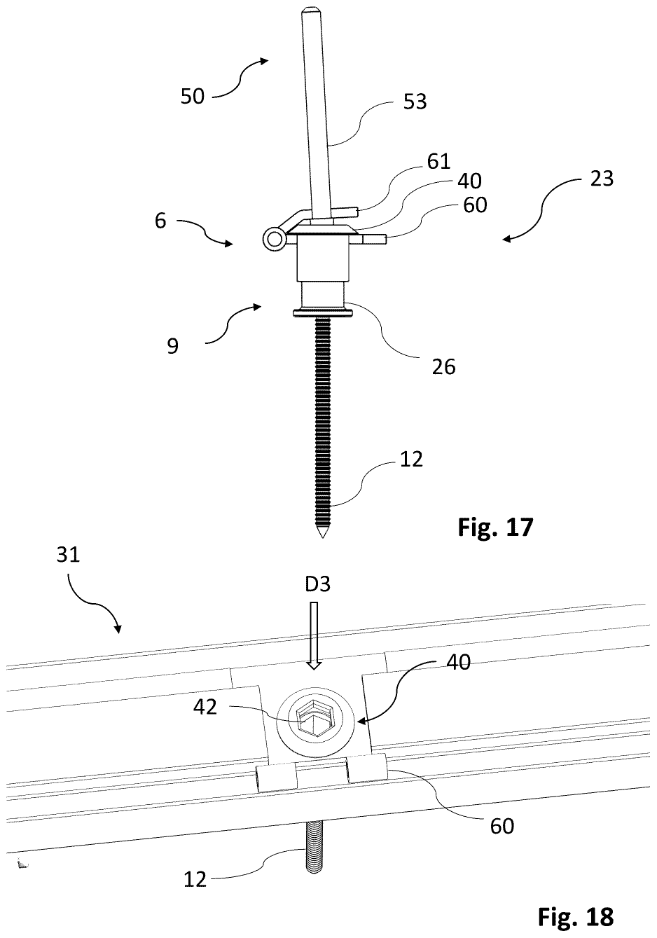

FIGS. 16-21 illustrate an embodiment where the first and second parts of the fitting arrangement is configured to be arranged in connection with a hinge of the openable element. The fitting arrangement is applicable to prevent the openable element 1 from being removed from the post 31 of the frame 3, which the openable element 1 is arranged onto via hinges 6, 7, see FIG. 1. In FIG. 16 the post 31 is illustrated from above with a hinge side fitting arrangement 23 and the hinge 6. An illustration from the same perspective, with the post 31 omitted, in order to better see the fitting arrangement 23 and the hinge 6, is seen in FIG. 17. The first fitting part 40 and the second fitting part 50 of the hinge side fitting arrangement 23 are attached to a first portion 60 and a second portion 61, respectively, of at least one of the hinges 6, 7, the first portion 60 and the second portion 61 being mutually rotatable about the axis A1.

The hinge side fitting arrangement 23 may be used in combination with the fitting arrangement 5 described above, or as a separate fitting arrangement. The attachment to a wall using a fixation device 9 as described above for the fitting arrangement 5 is equally applicable to components of the hinge side fitting arrangement 23.

The first fitting part 40 is arranged onto the post 31 with fixation device 9. The fixation device 9 comprises screwing means 12, which is screwed into the wall 4, see FIG. 1. The fixation device 9 further comprises a sleeve 26 attaching to the post 31 of the frame 3. A rigid and secure attachment of the hinge 6 that is thereby fixed to the wall may be provided. By screwing the first fitting part 10 directly into the wall 4, through the post 31 via the fixation device 9, any forces applied to the openable element 1 for movement prevented by the hinge side fitting arrangement 23 may not only be transferred to the post 31, but also to the wall 4. This increases the strength in the arrangement when the openable element 1 is exposed to forces due to e.g. an attempt of forced entry.

The second fitting part 50 is arranged with an attachment portion 53 onto the openable element 1. In FIG. 18 the post 31 is illustrated with the first fitting part 40 of the hinge side fitting arrangement 23, arranged onto the post 31. The first portion 60 of the hinge 6 to which the first fitting part 40 is attached is arranged onto the post 31. The first fitting part 40 comprises a slot 42 configured to receive the second fitting part 50, when closing the openable element 1.

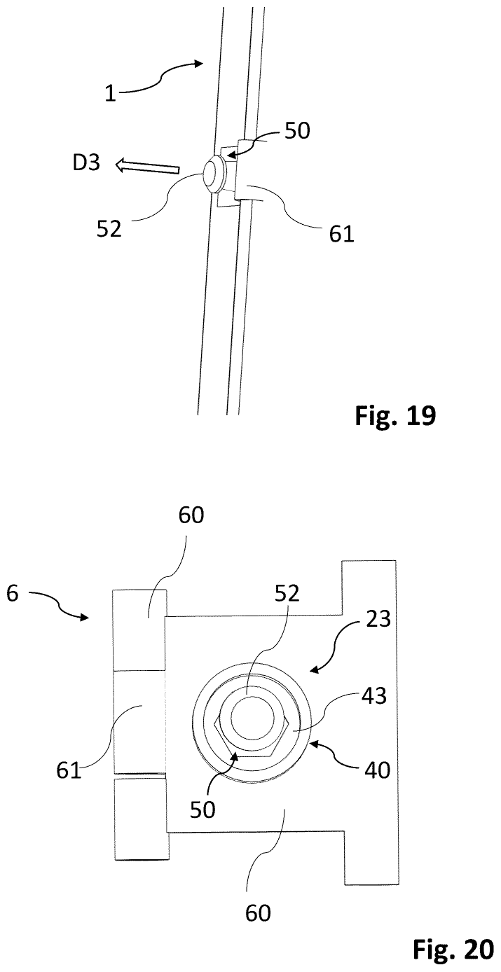

In FIGS. 19 and 20, the second fitting part 50 of the hinge side fitting arrangement 23 is seen arranged onto the openable element 1. The second portion 61 of the hinge 6 is seen arranged onto the openable element and attached to the second fitting part 50. The second fitting part 50 may however to a large extent be concealed by the openable element 1.

The second fitting part 50 comprises a head portion 52 configured to be received by the slot 42 of the first fitting part 40. The second fitting part 50 is configured to move in the extension plane of the openable element 1 and to protrude from the openable element 1 in a direction D3 substantially perpendicular to the opening direction D1 and the axis A1. When the first fitting part 40 and the second fitting part 50 are arranged onto the openable element 1 and the post 31 respectively, as intended, the head portion 52 moves, in the direction D3 into the slot 42, by closing the openable element 1, in a direction opposite to the opening direction D1. A hinge 6 with a hinge side fitting arrangement 23 in the closed state of the openable element 1 is seen without the attachment portion 41 of the first fitting part 40, the head portion 52 being inside the slot 42.

The first fitting part 40 is configured to allow the second fitting part 50 to be decoupled from the first fitting part 40 when opening the openable element 1, by rotational movement in the direction D1, rotating the openable element 1 around axis A1 provided by the at least one hinge 6, 7. The head portion 52 may however be inside the slot 42 even when the openable element 1 is slightly open in order to prevent the openable element to be removed from the post 31, also if the openable element 1 is slightly opened by force. The first fitting part 40 may comprise an abutment surface 43 which is configured to prevent the second fitting part 50 from being decoupled from the first fitting part 40 if the openable element 1 is or has been translatory moved in a direction which is not parallel to the direction D3. Such a translatory movement, may be a result of efforts to pry open the openable element 1, for example by applying a force onto the openable element 1, with a tool which is sticked in between the openable element 1 and the post 31. For such a translatory movement, the abutment surface 43 of the first fitting part 40 blocks the head portion 13 from being moved out from the slot 41 in a direction opposite to the direction D3.

The force is thereby resisted by forces between the first fitting part 40 and the second fitting part 50. Hinge side fitting arrangements 23 may be used on one or several hinges 6, 7.

The first fitting part 40 and the second fitting part 50 of the hinge side fitting arrangement 23 may alternatively be mounted onto the doorpost 31 and the openable element 1 without being attached to hinges 6, 7. It is possible to use several hinge side fitting arrangements for the openable element, of which some are attached to hinges. Both the ones attached to hinges and the ones not attached to hinges may then resist efforts to remove the openable element 1 from the post 31, by forces between first fitting parts 40 and second fitting parts 50 of the hinge side fitting arrangements 23.

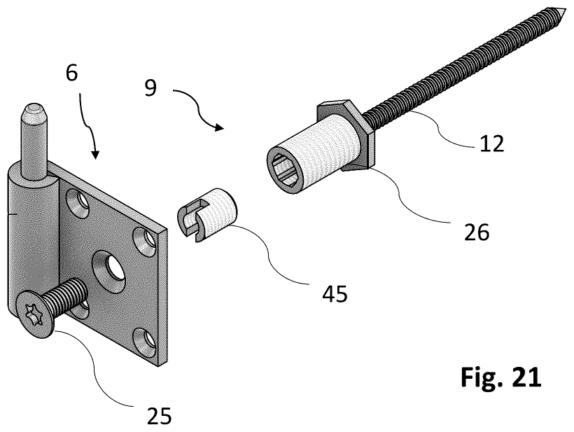

FIG. 21 illustrates an embodiment where with a hinge 6 for attachment to a frame and a wall by means of fixation device 9, comprising a screwing means 12 configured to extend into the wall. The hinge 6 may be screwed to the sleeve 26 via an adapter 45. The adapter 45 is configured to fit into the threaded hollow interior of the sleeve 26, and to have its own threaded hollow interior configured to receive the fitting screw 25 from the hinge 6. The adapter 45 comprises outer threads for threaded connection with the sleeve 26, and inner threads for threaded connection with the fitting screw 25 of the hinge 6. The hinge 6 constitutes the first part of the fitting arrangement. The hollow interior of the sleeve 26 may in one embodiment initially be non-threaded, and the adapter may be configured to be thread cutting, forming the threads when being screwed into the frame attachment screw.

In the drawings and specification, there have been disclosed preferred embodiments and examples of the invention and, although specific terms are employed, they are used in a generic and descriptive sense only and not for the purpose of limitation, the scope of the invention being set forth in the following claims.

1. A fitting arrangement for a frame of an openable element, the fitting arrangement comprising:
a first fitting part adapted to be arranged onto the frame;
a fixation device comprising
a sleeve having exterior threads and interior threads, the sleeve being adapted to be attached to an opening in the frame by means of the exterior threads;
a wall screw configured to extend through the sleeve and adapted to engage into a wall next to the frame, such that the sleeve is adapted to be attached to the wall, wherein the wall screw is rotatable relative to the sleeve;
a fitting screw configured to fix the first fitting part to the sleeve by engaging with the inner threads of the sleeve.

2. The fitting arrangement according to claim 1, further comprising a second fitting part adapted to be arranged to the openable element, the second fitting part being configured to engage with the first fitting part.

3. The fitting arrangement according to claim 2, wherein the first fitting part is configured to receive the second fitting part (11) when the openable element is moved into a closed state and wherein the second fitting part is removable from the first fitting part by movement of the openable element in an opening direction into an open state;
wherein the first fitting part is formed to receive the second fitting part in a first position or in a second position, wherein the second fitting part is removable from the first fitting part when the second fitting part is in the first position and prevented from being removed from the first fitting part when the second fitting part is in the second position, and wherein the second fitting part is moved to the second position when a force is applied to the openable element in a direction substantially perpendicular to the opening direction.

4. The fitting arrangement according to claim 3, wherein the first fitting part comprises a slot and wherein the second fitting part is configured to move along the slot when the openable element is moved between the closed state and the open state.

5. The fitting arrangement according to claim 4, wherein the second fitting part is configured to, when received by the first fitting part, move from the first position to the second position in a direction substantially perpendicular to an extension direction of the slot.

6. The fitting arrangement according to claim 4, wherein the second fitting part has a neck portion which has a width smaller than or equal to a width of the slot.

7. The fitting arrangement according to claim 6, wherein the second fitting part has a head portion with a width that is larger than the width of the neck portion and larger than the width of the slot.

8. The fitting arrangement according to claim 7, wherein the first fitting part comprises at least one first abutment surface shaped to receive the head portion of the second fitting part when in the first position.

9. The fitting arrangement according to claim 8, wherein the head portion has a width, in a plane perpendicular to a movement direction between the first and the second position, that prevents movement along the slot, when the second fitting part is in in the second position.

10. The fitting arrangement according to claim 7, wherein the first fitting part comprises at least one second abutment surface configured to block the head portion from moving along the slot when the second fitting part is in the second position.

11. The fitting arrangement according to claim 1, wherein the openable element is a door, and the frame is a door frame.

12. The fitting arrangement according to claim 1, wherein the opening direction is perpendicular to an extension plane of the openable element.

13. The fitting arrangement according to claim 2, wherein the first fitting part is a first hinge part that is adapted to be arranged on a post of the frame at a hinge side of the openable element;
the second fitting part is a second hinge part that is adapted to be arranged on the openable element that is openable relative to the frame;
wherein the second hinge part, when the openable element is in a closed position, engages with the first hinge part such that separation of the first and second hinge parts is only enabled by movement of the openable element towards an open position.

14. The fitting arrangement according to claim 3, wherein the first fitting part is arranged to two fixation devices, longitudinal center lines of the two fixation devices form a line, and a longitudinal center line of the second part when in the first position is offset from said line by a distance of at least 2 mm.

15. A door arrangement comprising a door, a frame and at least one of the fitting arrangements according to claim 1 arranged to the frame and/or the door.

16. A method of arranging a fitting arrangement to a frame of an openable element, the method comprising the steps of:
arranging a sleeve of a fixation device in an opening in the frame by means of exterior threads on said sleeve;
arranging a wall screw through the sleeve and the frame into a wall next to the frame, such that the sleeve is attached to the wall; and
arranging a first fitting part on the frame and attaching the first fitting part to the sleeve by a fitting screw engaging with interior threads in a hollow interior on the sleeve.
